(19) United States
(12) Patent Application Publication
(10) Pub. No.: US 2021/0094364 A1
(43) Pub. Date: Apr. 1, 2021

(54) RUN-FLAT TIRE

(71) Applicant: Zhixue TAI, New York, NY (US)

(72) Inventor: Zhixue TAI, New York, NY (US)

(21) Appl. No.: 16/583,271

(22) Filed: Sep. 26, 2019

(51) Int. Cl. B60C 17/06

(52) U.S. Cl. CPC B60C 17/06; B60C 2017/068

(57) ABSTRACT

A run-flat tire includes a tire casing and a steel rim connected to an opening side of the tire casing to form a cavity, wherein a shock absorbing elastic component is provided along a radial direction in the cavity, one end of the shock absorbing elastic component is connected to the tire casing, and a gap is provided between another end of the shock absorbing elastic component and an outer wall of the steel rim. Specifically, a first annular shock absorbing cushion is provided along a circumferential direction inside the cavity, one end of the shock absorbing elastic component is fixed on the tire casing, and another end of the shock absorbing elastic component is fixed on the first annular shock absorbing cushion; a second annular shock absorbing cushion is provided along the circumferential direction on the outer wall of the steel rim.

### TECHNICAL FIELD

The present disclosure belongs to the technical field of blowout-proof tires, specifically to a run-flat tire.

### BACKGROUND

A vehicle's tires with an inner tube or without an inner tube are subjected to a long-term abrasion generated by the tire itself while the vehicle is traveling in a high-speed mode. Tires bear the weight of the car body and therefore the internal air pressure of the tire changes. When the tire rotates rapidly and transiently collides with the ground while moving at a high speed, a high pressure is generated on the collided part of the tire due to air movement inside the tire, and an inward high pressure is generated on the collided part due to an outward air pressure inside the tire and high-speed collision with the ground. Especially, if the vehicle collides with an obstacle, the pressure on the collided part will increase suddenly, and thus, an abrupt tire blowout accident is likely to occur. Once the tire of the vehicle blows out, center of gravity of the vehicle shifts instantaneously, resulting in loss of control over the vehicle, which becomes the main reason accounting for various car accidents.

### SUMMARY

Based on the aforementioned issues in the background, objective of the present disclosure is to provide a run-flat tire to prevent the vehicle from getting out of control in case of a tire blowout.

To this end, the present disclosure provides the technical solutions as follows.

A run-flat tire, includes a tire casing, and a steel rim connected to an opening side of the tire casing to form a cavity, wherein a shock absorbing elastic component is provided along a radial direction of the tire in the cavity, one end of the shock absorbing elastic component is connected to the tire casing, and a gap is provided between another end of the shock absorbing elastic component and an outer wall of the steel rim.

In one embodiment, a first annular shock absorbing cushion is provided along a circumferential direction inside the cavity, one end of the shock absorbing elastic component is fixed on the tire casing, another end of the shock absorbing elastic component is fixed on the first annular shock absorbing cushion; a second annular shock absorbing cushion is provided along the circumferential direction on the outer wall of the steel rim, and a gap is provided between the second annular shock absorbing cushion and the first annular shock absorbing cushion.

Preferably, a protrusion is provided on a surface of the first annular shock absorbing cushion, extending far away from the shock absorbing elastic component, and a surface of the second annular shock absorbing cushion is provided with a groove matching with the protrusion.

Preferably, lengthwise sections of the protrusion and the groove are both triangular.

Preferably, a distance between the second annular shock absorbing cushion and the first annular shock absorbing cushion is 5-10 mm.

Preferably, a first steel plate is provided along the circumferential direction inside the tire casing, a second steel plate is provided along the circumferential direction inside the first annular shock absorbing cushion, and the shock absorbing elastic component is provided between the first steel plate and the second steel plate.

Specifically, the shock absorbing elastic component is a spring.

In one embodiment, the shock absorbing elastic component is a rubber shock absorbing block, one end of the rubber shock absorbing block is fixed with an inner wall of the tire casing, another end of the rubber shock absorbing block is hung in the air, and the outer wall of the steel rim is provided with a rubber cushion matching with the rubber shock absorbing cushion.

Preferably, a distance between the rubber shock absorbing block and the rubber cushion is 5-10 mm.

Specifically, one or more sets of the shock absorbing elastic components are provided inside the cavity along an axial direction of the tire.

Compared with the prior art, the present disclosure has the following technical effects.

1. According to the present disclosure, the shock absorbing elastic component is provided in the cavity formed by the tire casing and the steel rim. The shock absorbing elastic component can play a role in supporting the tire casing at the moment when the tire blowout occurs, so that the tire can maintain a normal operation for a certain period of time to avoid an accident.

2. According to the present disclosure, one end of the shock absorbing elastic component is connected to an inner wall of the tire casing, a gap is provided between another end of the shock absorbing elastic component and an outer wall of the steel rim, which can prevent a shock absorbing process from being influenced when the tire blowout occurs.

3. According to the present disclosure, a plurality of sets of the shock absorbing elastic components are provided inside the cavity along an axial direction of the tire. At this time, the tire is a non-pneumatic tire, and completely relies on the shock absorbing elastic components for support and cushioning.

### BRIEF DESCRIPTION OF THE DRAWINGS

To describe the technical solutions of the embodiments of the present disclosure more clearly, the drawings used in the embodiments are briefly described hereinafter.

FIG. 1 is a sectional view of a front view of a run-flat tire of one embodiment according to the present disclosure;

FIG. 2 is a sectional view of a side view of the run-flat tire of the embodiment according to the present disclosure;

FIG. 3 is an enlarged diagram of FIG. 2;

FIG. 4 is a sectional view of a side view of a non-pneumatic run-flat tire of one embodiment according to the present disclosure;

FIG. 5 is a sectional view of a side view of another non-pneumatic run-flat tire of one embodiment according to the present disclosure; and

FIG. 6 is a sectional view of a side view of a non-pneumatic run-flat tire of another embodiment according to the present disclosure.

### DETAILED DESCRIPTION OF THE EMBODIMENTS

To make the objectives, technical solutions and advantages of the embodiments of the present disclosure more clear, the technical solutions of the embodiments of the present disclosure will be described clearly and completely hereinafter with reference to the drawings in the embodiments of the present disclosure. Obviously, the described embodiments are merely a part of the embodiments according to the present disclosure, rather than all. All other embodiments without creative work made by those of ordinary skilled in the art based on the embodiments of the present disclosure should also be considered as falling within the scope of the present disclosure.

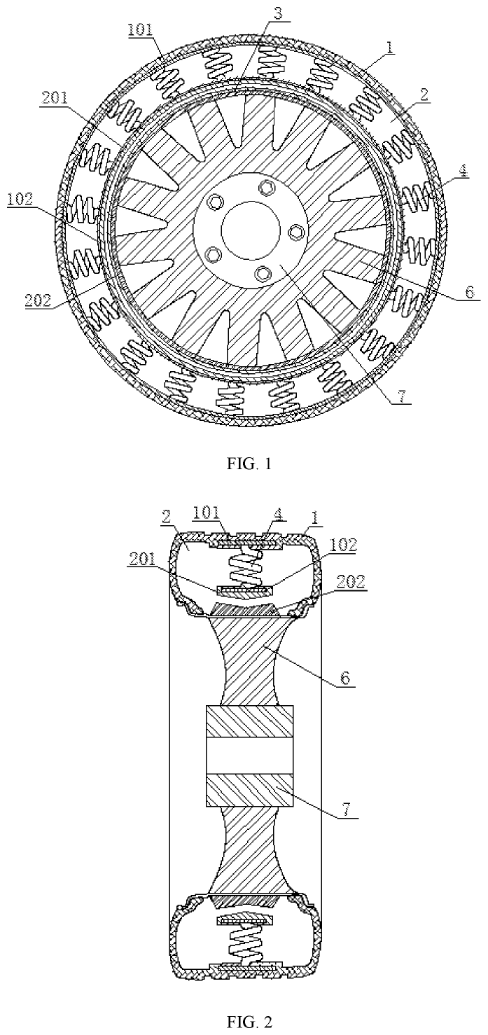

As shown in FIG. 1, the present embodiment provides a run-flat tire, including the tire casing 1, and the steel rim 3 connected to an opening side of the tire casing 1 to form the cavity 2. The shock absorbing elastic component 4 is provided along a radial direction of the tire inside the cavity 2. One end of the shock absorbing elastic component 4 is connected to the tire casing 1, and a gap is provided between another end of the shock absorbing elastic component 4 and an outer wall of the steel rim 3.

Specifically, in the present embodiment, as shown in FIGS. 1-3, the first annular shock absorbing cushion 201 is provided along a circumferential direction inside the cavity 2. One end of the shock absorbing elastic component 4 is fixed on the tire casing 1, and another end of the shock absorbing elastic component 4 is fixed on the first annular shock absorbing cushion 201, namely the first annular shock absorbing cushion 201 is hung in the air and connected to the tire casing 1 through the shock absorbing elastic component 4. The second annular shock absorbing cushion 202 is provided along the circumferential direction on the outer wall of the steel rim 3. A gap is provided between the second annular shock absorbing cushion 202 and the first annular shock absorbing cushion 201. Under a normal air pressure, a distance between the second annular shock absorbing cushion 202 and the first annular shock absorbing cushion 201 is 5-10 mm. When a tire blowout occurs, the shock absorbing elastic component 4 can play a role in supporting and protecting the tire casing 1. At this time, under action of pressure, the shock absorbing elastic component 4 drives the first annular shock absorbing cushion 201 to contact with the second annular shock absorbing cushion 202, preventing the vehicle from getting out of control casing at the moment when the tire blowout occurs.

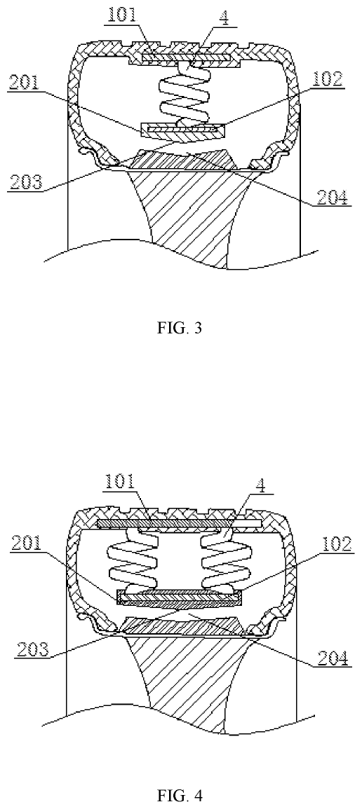

After the tire blowout occurs, action of the shock absorbing elastic component 4 enables the vehicle to continue to be driven without getting out of control. To ensure that the vehicle runs stably, that is, contact surface of the first annular shock absorption cushion 201 and contact surface of the second annular shock absorption cushion 202 don't slide, as shown in FIG. 3, the protrusion 203 is provided on a surface of the first annular shock absorbing cushion 201, extending far away from the shock absorbing elastic component 4. The protrusion 203 and the first annular shock absorbing cushion 201 form an integral structure. A surface of the second annular shock absorbing cushion 202 is provided with a groove 204 matching with the protrusion 203. In the present embodiment, lengthwise sections of the protrusion 203 and the groove 204 are both triangular.

In the present embodiment, to facilitate fixing of the shock absorbing elastic component 4, as shown in FIGS. 1 and 3, the first steel plate 101 is provided along the circumferential direction inside the tire casing 1. The second steel plate 102 is provided along the circumferential direction inside the first annular shock absorbing cushion 201. The shock absorbing elastic component 4 is provided between the first steel plate 101 and the second steel plate 102.

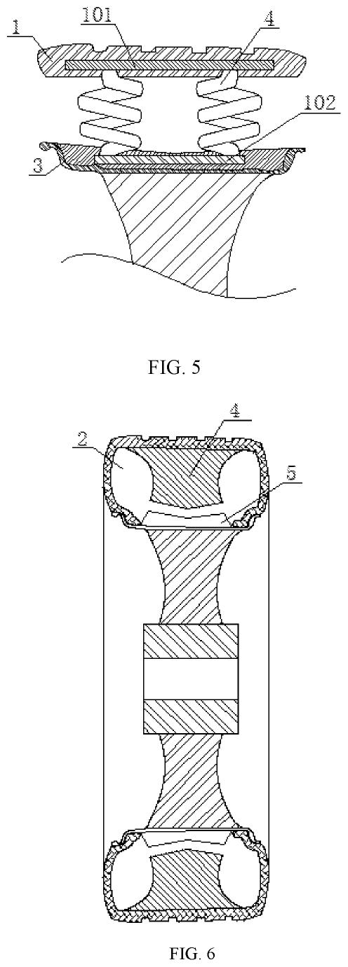

It should be noted that, in the present embodiment, the above-mentioned shock absorbing elastic components 4 are all springs. Additionally, it should be noted that, a number of sets of the shock absorbing elastic components 4 provided inside the cavity 2 along an axial direction of the tire are not limited to one. As shown in FIG. 4, two or more sets of the shock absorbing elastic components 4 may be provided At this time, the whole tire is a non-pneumatic tire, and completely relies on the shock absorbing elastic components 4 for support and cushioning. A structure of a non-pneumatic tire is also shown in FIG. 5. At this time, the tire casing 1 is formed only by an annular wall, and a rubber layer is provided on the outer wall of the steel rim 3, and the second steel plate 2 is embedded in the rubber layer. One end of the shock absorbing elastic component 4 is fixedly connected with the first steel plate 101 inside the tire casing 1, and another end of the shock absorbing elastic component 4 is fixedly connected with the second steel plate 102.

In other embodiment, as shown in FIG. 6, the shock absorbing elastic component 4 may be a rubber shock absorbing block. At this time, one end of the rubber shock absorbing block is fixed with an inner wall of the tire casing 1 and another end of the rubber shock absorbing block is hung in the air. The outer wall of the steel rim 3 is provided with the rubber cushion 5 matching with the rubber shock absorbing cushion. A distance between the rubber shock absorbing block and the rubber cushion 5 is 5-10 mm. In other embodiment, the rubber cushion 5 may not be provided, and only the rubber shock absorbing block is provided. The rubber shock absorbing block supports and protects the tire casing 1 when the tire blowout occurs.

It should be noted that, the tire casing 1 and the steel rim 3 of the present disclosure belong to the prior art, and their specific structures belong to common knowledge. As shown in FIGS. 1 and 2, the inner wall of the steel rim 3 is connected to the spokes 6. One end of each of the spokes 6 far away from the steel rim 3 is connected to the hub 7 which is used for connecting to an axle.

It should be noted that, as for those of ordinary skill in the art, without departing from the creative conceptions of the present disclosure, changes and improvements can be made, and should be considered as falling within the scope of the present disclosure.

What is claimed is:

1. A run-flat tire, comprising: a tire casing and a steel rim connected to an opening side of the tire casing to form a cavity, wherein a shock absorbing elastic component is provided along a radial direction of the tire in the cavity, one end of the shock absorbing elastic component is connected to the tire casing, and a gap is provided between another end of the shock absorbing elastic component and an outer wall of the steel rim.

2. The run-flat tire according to claim 1, wherein a first annular shock absorbing cushion is provided along a circumferential direction of the tire inside the cavity, the one end of the shock absorbing elastic component is fixed on the tire casing, another end of the shock absorbing elastic component is fixed on the first annular shock absorbing cushion; and
a second annular shock absorbing cushion is provided along the circumferential direction on the outer wall of the steel rim, a gap is provided between the second annular shock absorbing cushion and the first annular shock absorbing cushion.

3. The run-flat tire according to claim 2, wherein a protrusion is provided on a surface of the first annular shock absorbing cushion, extending far away from the shock absorbing elastic component, and a surface of the second annular shock absorbing cushion is provided with a groove matching with the protrusion.

4. The run-flat tire according to claim 3, wherein lengthwise sections of the protrusion and the groove are both triangular.

5. The run-flat tire according to claim 3, wherein a distance between the first annular shock absorbing cushion and the second annular shock absorbing cushion is 5-10 mm.

6. The run-flat tire according to claim 2, wherein a first steel plate is provided along the circumferential direction inside the tire casing, a second steel plate is provided along the circumferential direction inside the first annular shock absorbing cushion, and the shock absorbing elastic component is provided between the first steel plate and the second steel plate.

7. The run-flat tire according to claim 2, wherein the shock absorbing elastic component is a spring.

8. The run-flat tire according to claim 1, wherein the shock absorbing elastic component is a rubber shock absorbing block, one end of the rubber shock absorbing block is fixed with an inner wall of the tire casing, another end of the rubber shock absorbing block is hung in the air, an outer wall of the steel rim is provided with a rubber cushion matching with the rubber shock absorbing cushion.

9. The run-flat tire according to claim 8, wherein a distance between the rubber shock absorbing block and the rubber cushion is 5-10 mm.

10. The run-flat tire according to claim 1, wherein one or more sets of the shock absorbing elastic components are provided inside the cavity along an axial direction of the tire.

11. The run-flat tire according to claim 6, wherein the shock absorbing elastic component is a spring.
